(19) United States
(12) Patent Application Publication
(10) Pub. No.: US 2021/0348952 A1
(43) Pub. Date: Nov. 11, 2021

(54) Sensor Unit for a Sensor/Transmitter System and a Sensor/Transmitter System Having Such a Sensor Unit

(71) Applicant: KACO GmbH + Co. KG, Kirchardt (DE)

(72) Inventors: Jochen Bantel, Bretzfeld (DE); Andreas Paul, Untergruppenbach (DE); Joachim Reichert, Talheim (DE); Anatol Schwersenz, Neckarsulm (DE); Peter Selka, Backnang (DE); Jürgen Ulm, Schrozberg (DE); Oliver Vogel, Gaisbach (DE)

(21) Appl. No.: 17/277,741

(22) PCT Filed: Sep. 18, 2019
(86) PCT No.: PCT/EP2019/000270

§ 371 Date: Mar. 19, 2021

(30) Foreign Application Priority Data
Sep. 20, 2018 (DE) 10 2018 007 529.0

(51) Int. Cl. G01D 5/246

(52) U.S. Cl. CPC G01D 5/246; G01D 5/2452

(57) ABSTRACT

The sensor unit for a sensor/transmitter system is used to capture at least rotational and linear movements of a component (1) having magnetic poles. The sensor unit has at least one sensor which is at least one electrically conductive conductor bar (5) which is transverse with respect to the direction of movement of a magnetic field of the component (1). The relative movement between the magnetic field and the conductor bar (5) produces a voltage at said conductor bar, which voltage can be supplied to evaluation electronics (4).

The invention concerns a sensor unit according to the preamble of claim 1 as well as a sensor/transmitter system according to the preamble of claim 9.

For measuring technological tasks on rotating shafts or linear movements, magnetic and optical measuring systems or comparable measuring systems are used in industrial applications and in the automotive industry. For example, for control of a fuel injection and of the ignition point in internal combustion engines, the knowledge of the actual position of the crankshaft is important. The sensor systems used in this context usually comprise Hall sensors. They serve for detection of the magnetic field or of its change which is caused by the rotation either of a permanent-excited transmitter wheel as encoder or of a steel transmitter wheel with corresponding sensor with magnet. The sensors and the encoder are positioned in accordance with the case of application. An evaluation electronics interprets the signal course and supplies it to a control electronics. The known sensor units and sensor/transmitter systems for determining the absolute position recognition or the rotational direction recognition are complex and expensive, in particular when highest precision is required. In particular, the sensors must usually be mechanically positioned with high precision at housing regions in relation to the transmitter wheel.

The precision of the signals or the uniformity of the signal courses is often limited. On the one hand, positioning of the sensors in the housing is greatly tolerance-affected in general. In particular Hall ICs react sensitively to mechanical stress in the housing. A compensation of such shape and position tolerances of the shaft and of the housing does not exist. These imprecisions are found in the signal course. In addition, most sensors are limited with regard to their temperature of use.

The object of the invention resides in configuring a sensor unit of the aforementioned kind and a sensor/transmitter system of the aforementioned kind in such a way that they can be produced simply and inexpensively, can be easily mounted, and still fulfill highest precision requirements.

This object is solved for the sensor unit of the aforementioned kind in accordance with the invention with the characterizing features of claim 1 and for the sensor/transmitter system of the aforementioned kind in accordance with the invention with the characterizing features of claim 9.

The sensor unit according to the invention is characterized in that as a sensor only a simple conductor bar is employed that extends transversely to the movement direction of a magnetic field of the correlated component. As the component moves, a relative movement between the magnetic field and the conductor bar is produced so that a voltage is produced in the conductor bar. It is detected and supplied to the evaluation electronics.

The electrically conducting conductor bar is an inexpensive component that can be installed directly into the respective device, for example, immediately into a seal with which a rotating shaft is sealed. By means of the conductor bar it is possible to record very precise signal courses. In this way, it is possible in a simple but still reliable manner to reduce shape and position deviations of the component. When the sensor unit is used, for example, in an internal combustion engine of a motor vehicle, the efficiency of the internal combustion engine can be increased in this manner. Also, emissions can be reduced in this way and resources can be saved also. In the sensor itself, no expensive and rare materials are required.

The sensor/transmitter system that comprises the sensor unit according to the invention not only can detect rotational and linear movements but, for example, also the rotational speed, the torque, the frequency, the position, the movement direction or position and shape deviations of a component comprising a magnetic pole. This list is not to be understood as cumulative.

The conductor bar ensures a long service life.

Since the conductor bar can be integrated directly into a component, for example, a seal or sealing system, the conductor bar can provide corresponding output signals from which the desired information, for example, the rotational speed, the rotational direction or an angle position of a shaft can be derived. This information can be utilized for an intelligent motor management.

The conductor bar can be used without problems at very low and also at very high temperatures so that failure of the sensor cannot occur.

Advantageously, the voltage is generated by a charge separation in the conductor bar. This charge separation occurs when the conductor bar is positioned in the movement field of the magnetic field. Due to the relative movement between the magnetic field and the conductor bar, the charge separation is realized which leads to the voltage in the conductor bar that is to be evaluated. This voltage can be evaluated by the evaluation electronics and utilized for regulation and/or control.

In a constructively very simple embodiment, the conductor bar is part of a conductor wire. In this way, the conductor bar can be embodied and aligned in relation to the magnetic field of the moving component in a very simple manner.

In a particularly advantageous embodiment, the conductor bar is located on a support which, for example, can be a flexible printed board. For example, the conductor bar can also be printed on or in a 3D matrix. It enables the use of the sensor unit in various applications due to its high flexibility.

It is possible to provide on both sides of the support at least one conductor bar. Both conductor bars can then be used for different functions.

In an advantageous embodiment, the conducting wire can be formed, for example, in a meander shape or in parallel arrangement by a suitable manufacturing method of at least two or more conductor bars.

Advantageously, the conductor bars on both sides of the support are electrically conductingly connected to each other.

For reducing the total reluctance and thus for increasing the magnetic flux and the magnetic flux density in the magnetic circuit, it is advantageous when a high permeable layer is provided behind the outermost printed board. This high permeable layer can be comprised of mu-metal, for example. The high permeable materials have also the advantage that they can shield against outer foreign fields so that the measuring precision cannot be impaired by such outer foreign fields.

In an advantageous embodiment, the conductor bar on one side of the support detects the movement of the component and the conductor bar on the other side of the support a movement imprecision and/or shape/position deviation of the component. When the component is a shaft, for example, the rotational speed can then be detected with one conductor bar, for example, and the shaft eccentricity can be detected with the other conductor bar, for example.

In a particularly advantageous embodiment, the support comprises at least one bending line. In this way, there is the possibility of bending the sensor element or its support such that the conductor bars are positioned in several support elements resting on each other. In addition, an optimal signal level is obtained by a suitable arrangement of the conductor bars in multiple planes.

There is the advantageous possibility of integrating a plurality of sensors by a suitable arrangement and connection of the conductor bars in the multiple planes.

Instead of bending the support, it is also possible, for example, to coil the support in a desired degree, whereby the conductor bars are also positioned in multiple planes.

In an advantageous embodiment, the support is connected directly to the evaluation electronics. Then the support and the evaluation electronics form the sensor unit which is delivered as a pre-manufactured assembly and, for example, can be installed by the customer.

The sensor/transmitter system according to the invention is characterized in that it comprises the sensor unit according to the invention which is correlated with the moving component that is provided with the magnetic pole. When the component with the magnetic pole moves, a relative movement between the sensor unit and the magnetic field resulting from the magnetic pole occurs and leads to the voltage to be measured being produced in the respective conductor bar.

The component is preferably an encoder, for example, a transmitter wheel. The encoder surrounds a shaft whose movements can be reliably detected by the sensor unit.

The magnetic poles are located advantageously at the circumference or at the end face of the encoder.

The magnetic poles are formed by permanent magnets or solenoids that are provided, for example, at the circumference or the end face of the encoder.

However, the magnetic poles can also be formed in that the encoder is comprised, for example, of a sheet metal part with soft magnetic properties having arranged at its circumference magnetic particles from which the poles are produced by a magnetizing process.

In another preferred embodiment, the sensor unit is used for a rotating shaft which comprises a fixedly attached multi-pole permanent magnet-excited transmitter wheel. One or a plurality of sensor units are correlated with this transmitter wheel, for example, diametrically oppositely positioned relative to each other. When in a preferred embodiment they are provided with the flexible supports, for example, printed boards, the sensor units can be installed in a curved arrangement in accordance with the curvature of the transmitter wheel. Advantageously, on both sides of the support at least one conductor bar is arranged, respectively, and is preferably formed of multiple sensor wires that are embodied in a meander shape and electrically connected to each other. Alternatively, coiling of the bar arrangement is possible also. Preferably, copper is used for the conductor bar or the conductor wire.

In order for the induced voltages of the individual conductor bars on the arc-shaped sensor unit to summate, they must have relative to each other the same angle distance as the poles on the transmitter wheel.

In case of such a configuration, for example, the conductor bar with which the rotational speed is detected is located on the inner layer of the sensor unit. Correspondingly, the conductor bar with which a shaft run-out is detected is located on the outer layer of the support.

The signals that are produced by the conductor bars located at the inner side of the support are superimposed and serve for detection of the rotational speed as well as of the speed of the transmitter wheel. These inwardly located conductor bars provide a reference value for the signal evaluation of the shaft detection.

The signals of the conductor bars on the outer side of the sensor units are superimposed. When the shaft has no eccentricity (the shaft is running true). then a horizontal line with sensor voltage 0 results in the voltage/time diagram.

When however a shaft eccentricity occurs, then the two sensor units with their outwardly positioned conductor bars provide different voltage/time curves which extend approximately in a sine shape and deviate from each other. The magnitude of the amplitudes of these curves is a measure for the magnitude of the shaft eccentricity.

Advantageously, the sensor unit comprises at least two conductor bars, extends about 360°, and has a magnetization pattern with uniform pole pitch.

In this context, it is furthermore possible that the magnetization pattern with uniform pole pitch comprises at least one reference marker.

In another advantageous embodiment, the sensor unit comprises at least two conductor bars, extends about 360°, and is provided with a magnetization pattern with a non-uniform pole pitch.

When the sensor unit is embodied such that multiple conductor bars for different signal evaluations are provided on the support, different functions, for example, the rotational speed, a shaft run-out, and the like, can be detected with the sensor unit.

Advantageously, along the component at least two sensor units are arranged so that signal tapping can be performed reliably.

Advantageously, the component is magnetized such that an amplitude and/or frequency modulation is possible. In this way, in an advantageous manner, an absolute position recognition (angle position detection) of a shaft is possible, for example.

An absolute position recognition is also possible by use of the vernier principle.

In order to be able to adapt the signal height optimally to the case of application, the poles of the component can be arranged differently in y direction in a targeted manner.

The subject matter of the application results not only from the subject matter of the individual claims but also from the specifications and features disclosed in the drawings and in the description. Even if they are not subject matter of the claims, they are claimed as important to the invention, provided they are, individually or in combination, novel in relation to the prior art.

Further features of the invention result from the additional claims, the description, and the drawings.

The invention will be explained in more detail with the aid of a few embodiments illustrated in the drawings. It is shown in:

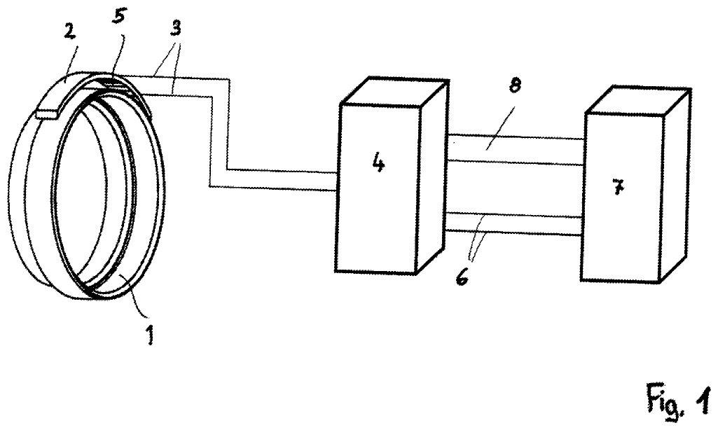

FIG. 1 in schematic illustration a first embodiment of a sensor/transmitter system according to the invention;

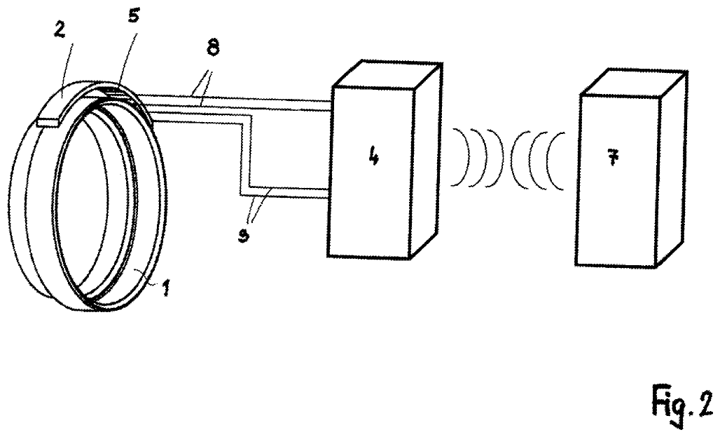

FIG. 2 in schematic illustration a further embodiment of a sensor/transmitter system according to the invention with indicated wireless communication;

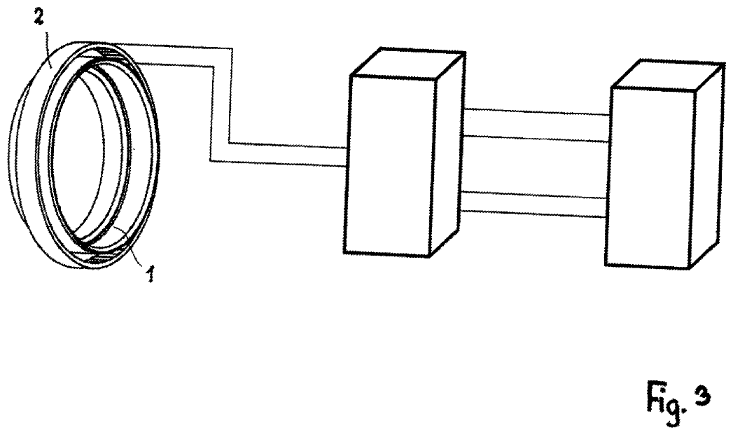

FIG. 3 in an illustration corresponding to FIG. 1, a further embodiment of a sensor/transmitter system according to the invention;

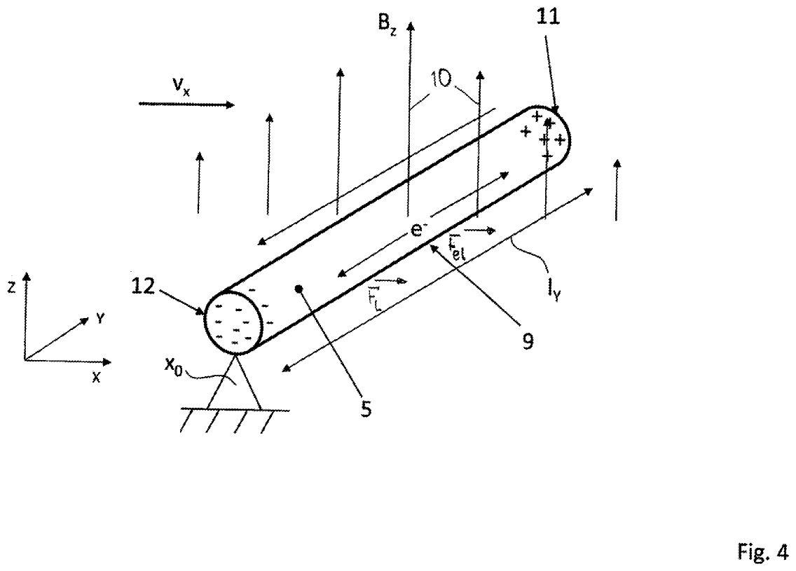

FIG. 4 in an enlarged illustration a conductor bar of the sensor unit according to the invention;

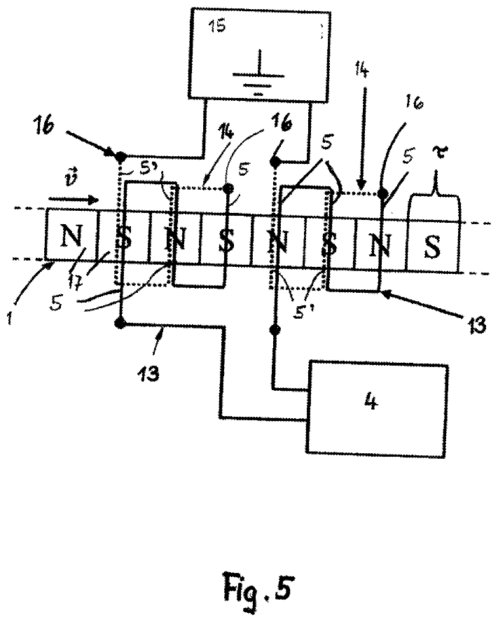

FIG. 5 an embodiment of a sensor unit according to the invention in schematic illustration;

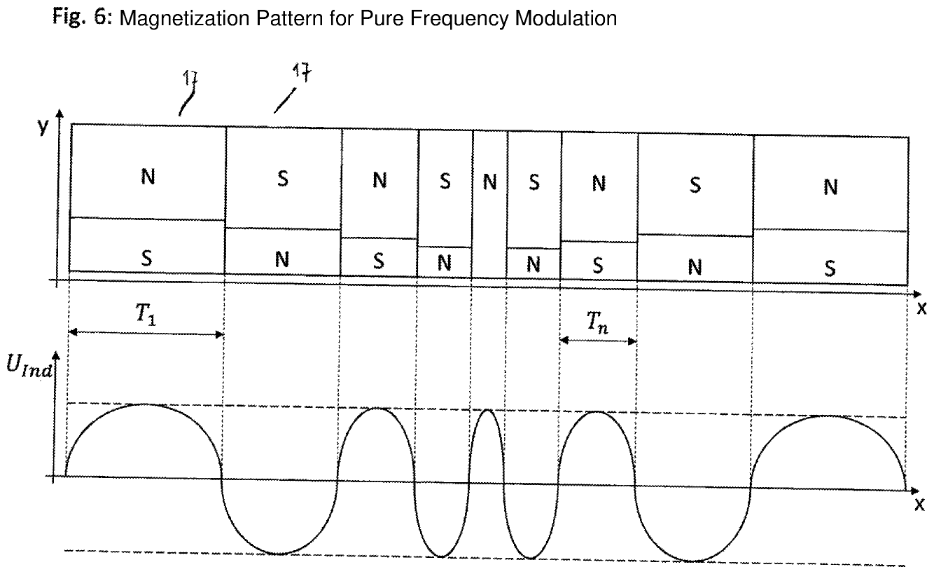

FIG. 6

to

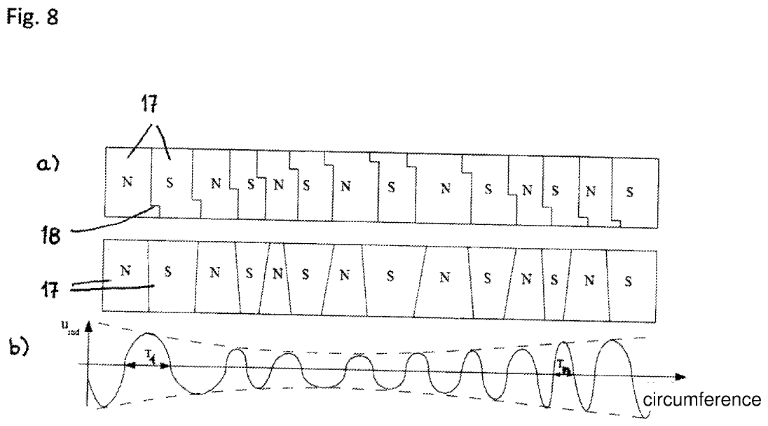

FIG. 8 different magnetization patterns of an encoder of the sensor/transmitter system according to the invention;

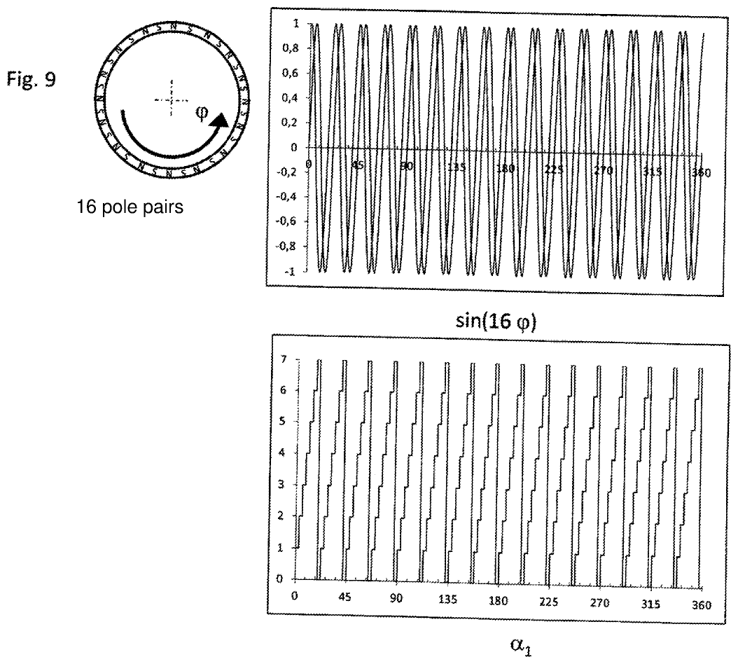

FIG. 9

to

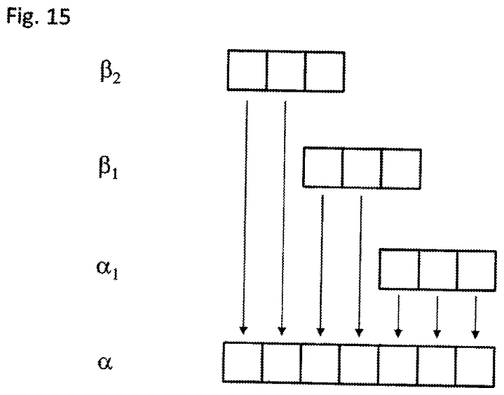

FIG. 15 an encoder of the sensor/transmitter system according to the invention for use of the vernier principle;

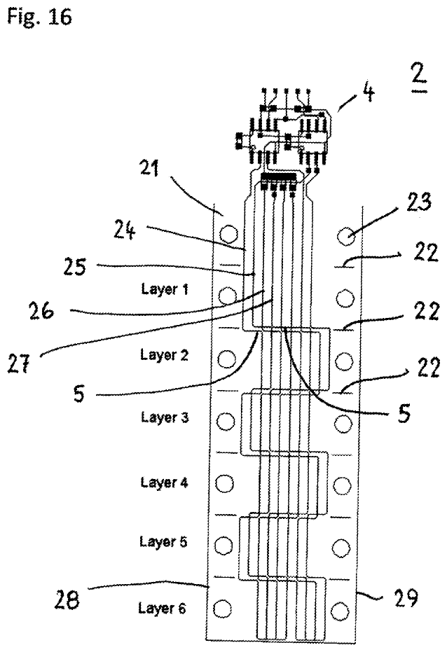

FIG. 16 a further embodiment of a sensor unit according to the invention;

FIG. 17 in schematic illustration the sensor unit according to FIG. 16 in folded state;

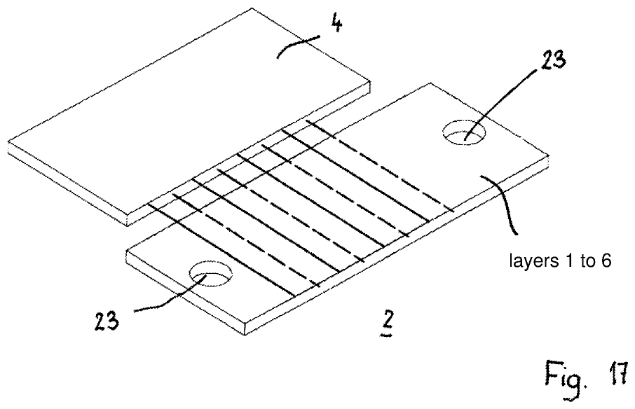

FIG. 18 in schematic illustration a further embodiment of a sensor unit according to the invention;

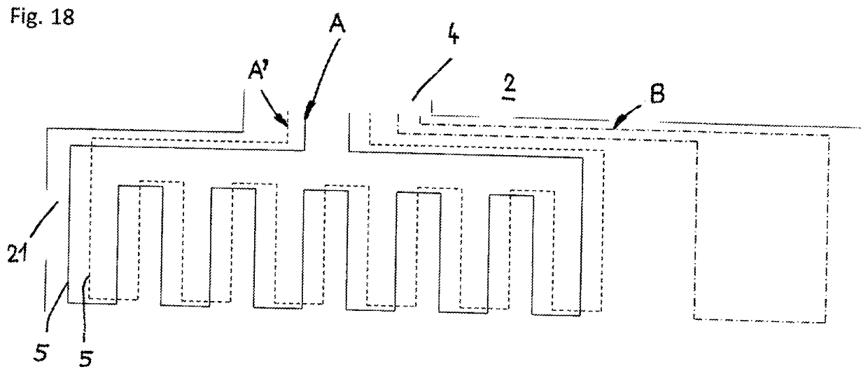

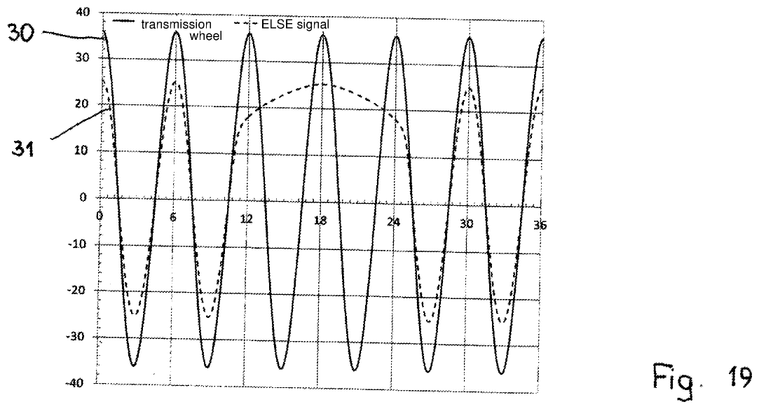

FIG. 19 the signals of a transmitter wheel as well as of a sensor unit of the sensor/transmitter system according to the invention;

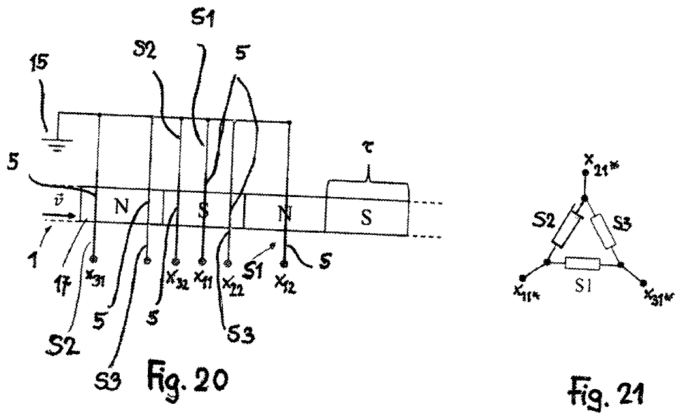

FIG. 20

and

FIG. 21 in schematic illustration the circuit of three conductor bars of a sensor unit according to the invention;

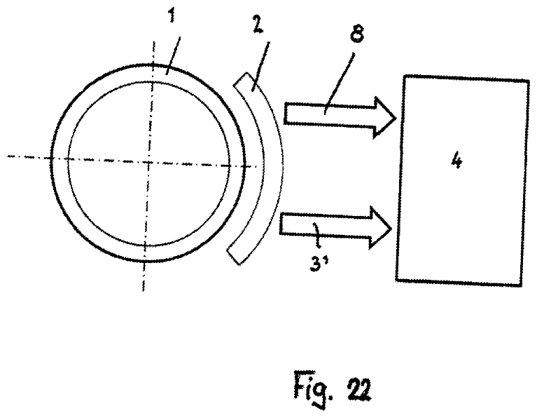

FIG. 22 in schematic illustration a further embodiment of the sensor/transmitter system according to the invention;

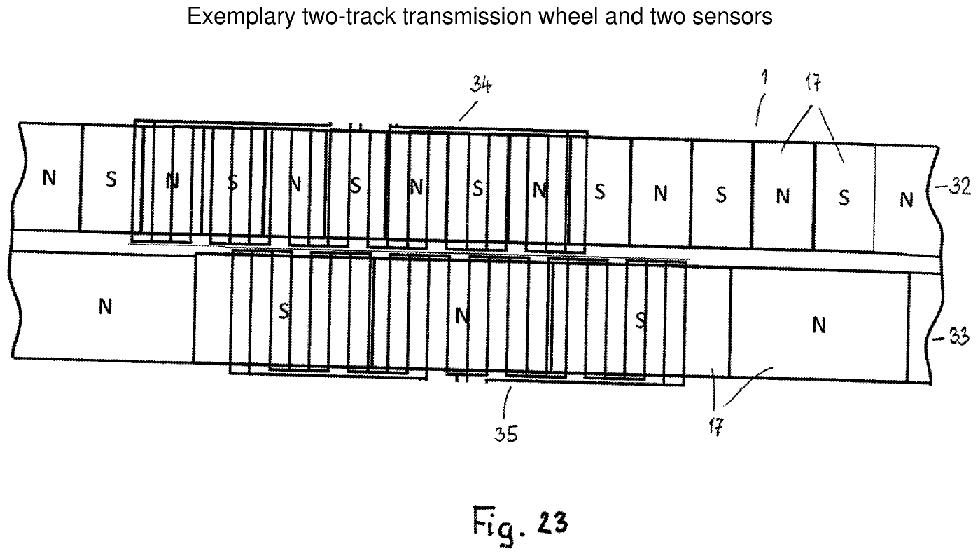

FIG. 23 in schematic illustration a two-track transmitter wheel with two sensors;

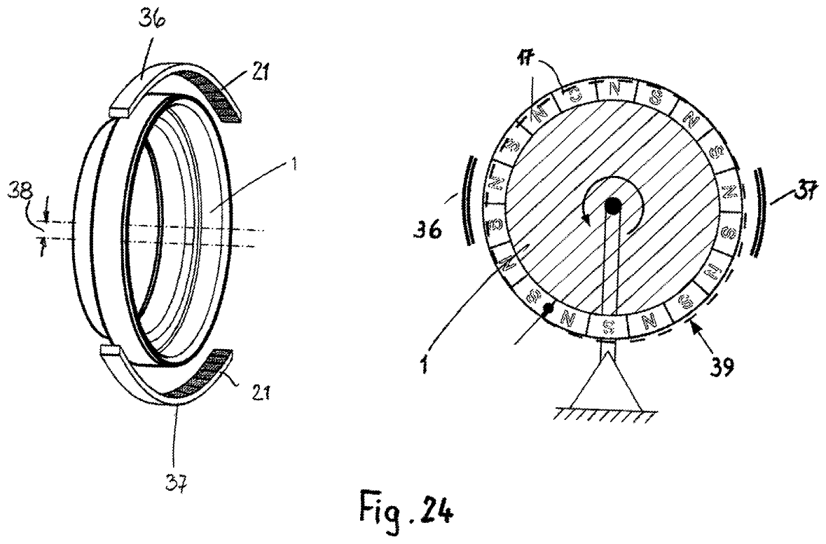

FIG. 24 in schematic illustration the detection of a shaft run-out of a transmitter wheel by the sensor/transmitter system according to the invention;

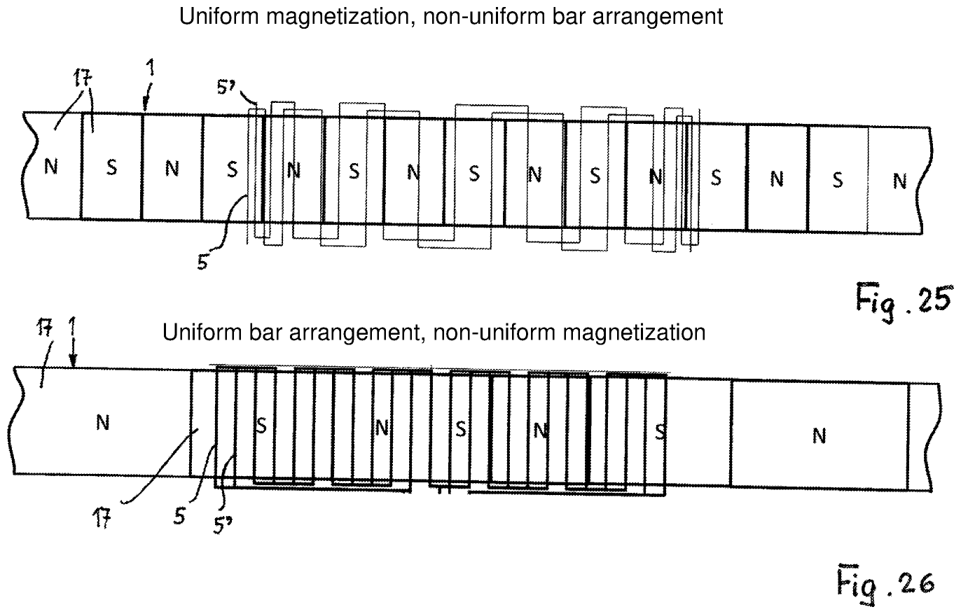

FIG. 25 in schematic illustration a sensor/transmitter system according to the invention with a uniform magnetization and a non-uniform arrangement of the conductor bars;

FIG. 26 in schematic illustration a sensor/transmitter system according to the invention with a uniform arrangement of conductor bars and a non-uniform magnetization.

The embodiments explained in the following of sensor systems with which an absolute or relative position recognition and/or a rotational direction recognition of rotating components is possible are characterized in that they can be produced inexpensively, still provide a high recognition precision, have a long service life, and can be used across a wide temperature range. The sensor systems are used in industrial applications and in particular in the automotive industry. A preferred application field is the use of the sensor system in a crankshaft sealing flange in which the sensor system is integrated.

The sensor system comprises a sensor/transmitter system. In FIG. 1, a transmitter wheel 1 is schematically illustrated as an example of an encoder which is fixedly seated on a rotating machine part, in particular a shaft. The transmitter wheel 1 is provided at the circumference with magnets (not illustrated) which upon rotation of the transmitter wheel 1 about its axis interact with a sensor element 2. The sensor element 2 extends across a portion of the circumference of the transmitter wheel and is connected by signal lines 3 to an evaluation electronics 4. The sensor element 2 and the evaluation electronics 4 form a sensor unit in the embodiment.

In a manner to be described in the following, the sensor element 2 is provided with conductor bars 5 which are comprised of electrically conducting material. The transmitter wheel 1 which is rotating about its axis with its permanent magnets produces a magnetic field which changes over time and which, due to the Lorentz force, leads to a charge displacement in the conductor bars 5. This charge displacement leads to an analog sensor signal that is supplied via the signal lines 3 to the evaluation electronics 4. It processes the analog sensor signals and digitalizes them. The digital output signal of the evaluation electronics 4 is supplied via signal lines 6 to a control unit 7 which evaluates the output signals. Depending on the configuration of the sensor element 2, the signals emitted by it can provide information about the rotational speed or the rotational direction of the transmitter wheel but also other information.

The control unit 7 can also serve to provide the evaluation electronics 4 with the required supply voltage 8.

The sensor element 2 can be integrated without additional centering and mounting devices directly in the application.

FIG. 2 shows in schematic illustration a sensor system that is self-sufficient with respect to energy. The sensor element 2 with the conductor bars 5 is correlated with the transmitter wheel 1. The sensor signals are supplied via the signal lines 3 to the evaluation electronics 4.

In contrast to the embodiment according to FIG. 1, the bidirectional data transmission between the evaluation electronics 4 and the control unit 7 is realized wireless.

The sensor element 2 supplies the evaluation electronics 4 with the required supply voltage 8. In other respects, this embodiment is of the same configuration as the preceding embodiment.

The sensor system according to FIG. 3 corresponds to the embodiment according to FIG. 1. The difference resides in that the sensor element 2 extends not only across a portion of the circumference of the transmitter wheel 1 but about the entire circumference.

In the embodiment variant according to FIG. 2, the sensor element 2 can also be embodied as a 360° sensor element in accordance with FIG. 3.

FIG. 4 shows in enlarged illustration in an exemplary fashion the conductor bar 5 which is embodied as an electrical conductor. It is provided stationarily and is positioned at a minimal distance to the rotating transmitter wheel 1. The stationary support of the conductor bar 5 is indicated by x₀.

The sensor voltage is produced by a charge separation in the conductor bar 5. When the conductor bar due to a relative movement intercepts the magnetic field lines 10 of the rotating transmitter wheel 1, the charge carriers 9 (electrons) which are present in the conductor bar 5 are subjected to the Lorentz force F_{L}.

Due to this charge separation, an electrical field E builds along the conductor bar 5 with the length l_{y} and counteracts the charge separation. In the stationary situation, a force balance between the electrostatic force Fₑₗ and the Lorentz force F_{L} is produced:

F_{L}=Fₑₗ

For the Lorentz force F_{L} the following applies:

F_{L}=e·B·v.

In this context, it is presupposed that the speed vector \vec{v} is perpendicular to the vector of the magnetic flux density B. In this context, e is the total charge of the charge carrier 9.

For the electrostatic force Fₑₗ the following applies.

Fₑₗ=e·E

When these equations are inserted into the above equation, the following results:

e·B_{z}·vₓ=−e·E.

It follows

B_{z}·vₓ=−E.

With the known equation

$$E = \frac{U}{{I}_{y}}$$

it follows thus

U=−B_{z}·l_{y}·vₓ.

In this context, l_{y} means the length of the conductor bar 5.

In this manner, the voltage U at the conductor bar 5 can be calculated. By rotation of the transmitter wheel 1, the magnetic field has a transversal movement direction. The stationary conductor bar 5 is positioned in the transversal magnetic field B which moves at the speed vₓ through the conductor bar 5. This leads to the described charge separation and thus to an electrical voltage drop along the conductor bar 5. The electrical repulsive forces Fₑₗ and the Lorentz force F_{L} form a balanced state. In the absence of the outer magnetic field B, the charge separation is canceled again.

By suitable embodiment, for example, number or length of the bars or multiple layers, the amplitude of the sensor output signal can be adjusted.

FIG. 5 shows an embodiment for the sensor element. It comprises two conductor bar groups 13 and two conductor bar groups 14 which are positioned in different planes. Each conductor bar group 13, 14 is provided with parallel extending conductor bars 5, 5′. Advantageously, a high permeable material such as a mu metal is provided behind the conductor bar groups 13 and 14. By means of such a material, the total reluctance is reduced so that the magnetic flux and thus the magnetic flux density in the magnetic circuit is increased. Also, such a material can shield against outer foreign fields.

In the embodiment, each conductor bar group 13, 14 comprises conductor bars 5, 5′ that extend parallel to each other and extend perpendicularly to the speed vector \vec{v} of the magnetic field. The conductor bars 5, 5′ of each conductor bar group 13, 14 are connected electrically conductingly to each other. Preferably, a conducting wire is used which follows a meander-shaped course so that the conductor bars 5, 5′ extending parallel to each other are formed.

The conductor bar groups 13, 14 are conductingly connected to a reference potential 15 and connected to the evaluation electronics 4.

The conductor bar groups 13, 14 arranged in two different planes are conductingly connected at through connection points 16 to each other which penetrate the intermediate layer located between the conductor bar groups 13, 14.

In FIG. 5, a part of the transmitter wheel 1 with its permanent magnets 17 at the circumference is illustrated. The permanent magnets 17 are arranged sequentially alternatingly as north and south poles. The pole pitch T is constant.

The conductor bars 5, 5′ are aligned such that they are positioned parallel to the axis of rotation of the transmitter wheel 1 and perpendicularly to the speed vector \vec{v}. Upon rotation of the transmitter wheel 1, a charge separation is produced in the conductor bars 5, 5′ due to the relative movement between the magnetic field lines of the permanent magnets 17 of the transmitter wheel 1 and the conductor bars 5, 5′ so that voltage U is produced at the conductor bars 5, 5′ which is evaluated and processed by the evaluation electronics 4 in order to determine, for example, the rotational direction, the rotational speed or the angle position of the rotating machine part.

The sensor system is characterized by a very compact configuration. The conductor bar groups 13, 14 can be designed such that a relatively high number of conductor bars 5, 5′ are formed while providing compact dimensions. A very high useful signal level is produced which enables a reliable evaluation of the signals supplied by the sensor element. The sensor element is advantageously embodied as a multi-layer printed board. The conductor bar groups 13, 14 are located on both sides of the printed board and are connected by the through connections 16 in a known manner electrically conductingly to each other.

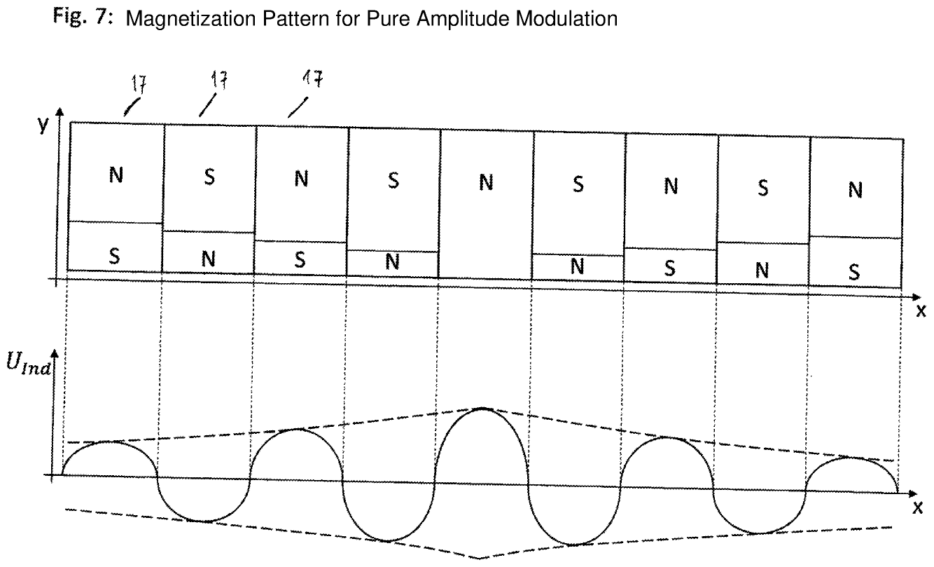

FIGS. 6 and 7 show two exemplary magnetization patterns and their voltage course for the transmitter wheel 1 in an exemplary manner for a single-rod sensor. Illustrated are the permanent magnets 17 of the transmitter wheel 1.

FIG. 6 shows a frequency modulated magnetization pattern. The amplitude height is corrected by the double poles in y direction. This applies for a constant speed. The frequency modulation is achieved by a corresponding different width of the permanent magnets 17 measured in x direction. The width of the individual permanent magnets 17 initially decreases about the circumference and subsequently increases again. The frequency course about the circumference of the transmitter wheel relative to the voltage U_{ind} shows that the amplitude of the curve is identical, but the half frequency T varies on the other hand about the circumference of the transmitter wheel. The narrower the individual poles of the permanent magnets 17 are, the greater the frequency T becomes. As an example, the frequency T₁ in the range of the widest permanent magnets 17 and the frequency Tₙ in the range of a narrower pole are illustrated.

As a supplement to FIG. 6, FIG. 7 shows a pole pattern with which a pure amplitude modulation is achieved. In contrast to the magnetization pattern according to FIG. 6, the permanent magnets 17 in x direction have the same width. In this way, the amplitude height varies about the circumference of the transmitter wheel while the half frequency T remains the same about the circumference of the transmitter wheel.

A combination of frequency and amplitude modulation is also conceivable.

FIG. 8 shows such an example. By a corresponding configuration of the permanent magnets 17 or pole patterns, the desired modulation course can be adjusted. The frequency as well as the amplitude change about the circumference of the transmitter wheel. The pole patterns according to FIGS. 6 to 8 described as examples show that the sensor system can be optimized depending on requirements and/or case of application.

As an example, the pole patterns of FIGS. 6 and 7, detected by a sensor arranged about 360°, can output a uniform incremental signal and, in addition, the respective frequency and/or amplitude modulated signal by detection with a single-rod sensor.

Alternatively, signal modulations can also be achieved by a suitable bar arrangement.

There is also the possibility to represent the described magnetization patterns as multi-pole encoders. At the circumference of the transmitter wheel 1, magnetic particles are located which are embedded in a binder material. By a magnetization process, the permanent magnet poles are formed at the circumference of the transmitter wheel 1.

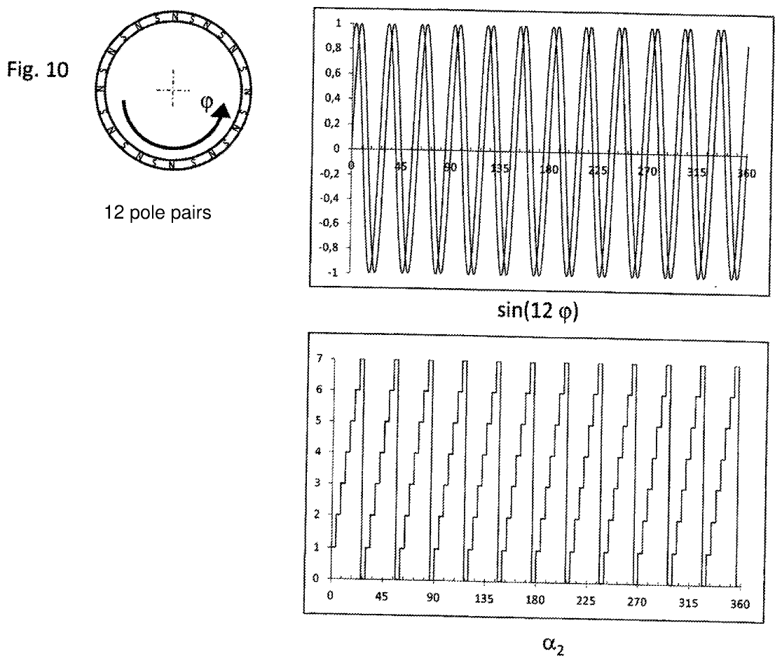

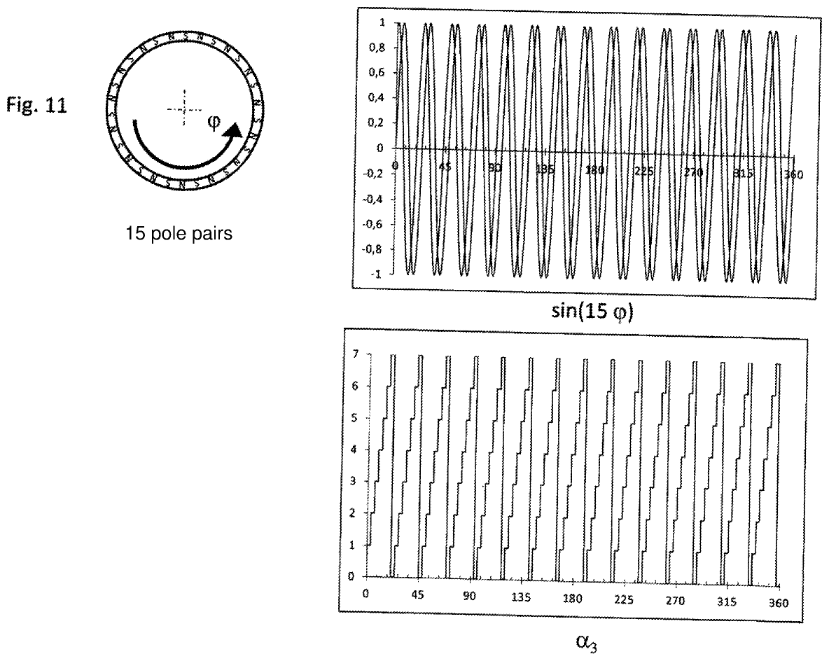

With the aid of FIGS. 9 to 11, in an exemplary fashion an absolute coding according to the vernier principle is described that can be used in the sensor/transmitter system. Since this principle is known, it will be explained only briefly however. The transmitter wheel 1 comprises three incremental tracks with different numbers of teeth. In FIGS. 9 to 11, these incremental tracks are illustrated in an exemplary fashion as three transmitter wheels 1 that have 12, 15, and 16 teeth (pole pairs). These three incremental tracks are separately sensed and digitalized.

The upper right illustrations of FIGS. 9 to 11 show the sine signals of the three tracks about an angle of rotation of 360°. Form this sine curve, the phase angles α₁ to α₃ are determined by digitalization.

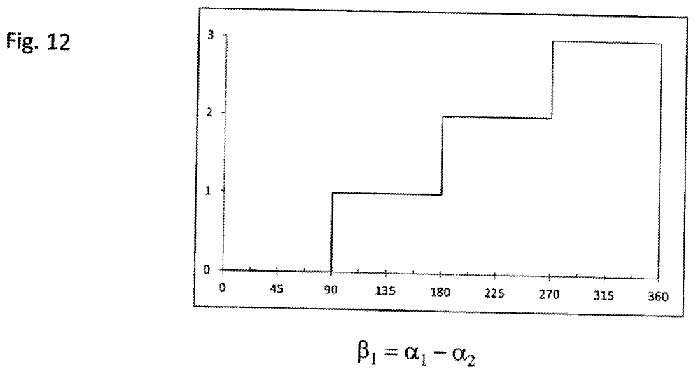

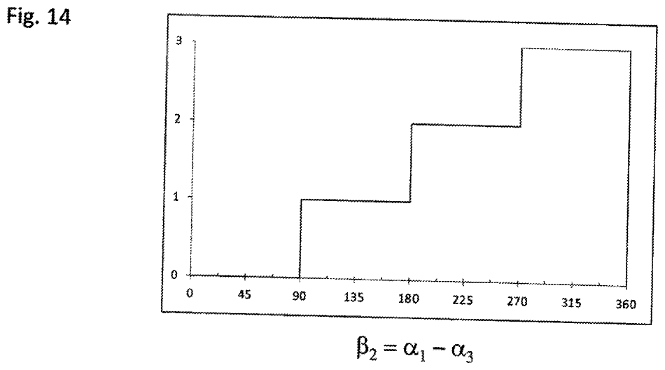

The phase correlations β₁ (FIG. 12) and β₂ (FIG. 14) are determined based on the phase angles α₁ to α₃. The course of the curve in relation to the phase correlation β₁ is determined based on the correlation β₁=α₁−α₂ and the phase angle β₂ based on the correlation β₂=α₁−α₃.

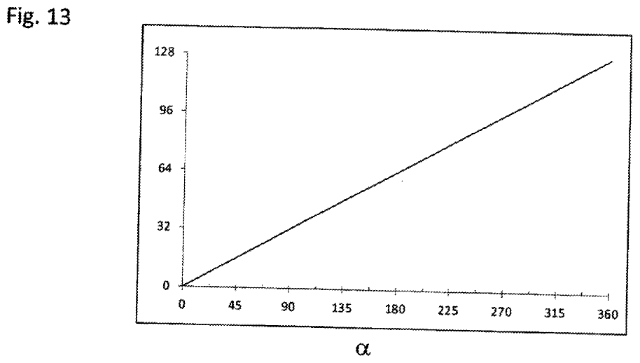

Based on the phase correlations β₁ and β₂, the angle value α can be calculated. This angle value is illustrated in FIGS. 13 and 15. The angle value α (FIG. 13) resulting from the phase correlation β₁ extends linearly about an angle range of 360°.

In FIG. 15, it is schematically illustrated how the angle value α can be calculated from the angle correlations β₁, β₂. The value α₁ provides the fine resolution.

Depending on the case of application of the sensor system and on the employed transmitter wheel, the number and/or the distance of the conductor bars 5, 5′ from each other can be changed. For example, a 0° sensor can be produced simply in that the sensor element 2 comprises only a single conductor bar 5.

The sensor elements 2 can be embodied from a 0° sensor element up to a 360° sensor element wherein a corresponding number of conductor bars 5, 5′ can be employed which can be positioned on different layers. The type of sensor elements depends on the pole number of the employed permanent magnets 17.

The conductor bars 5 can be positioned at uniform distances from each other. Instead of such a periodic arrangement, also an aperiodic arrangement of the conductor bars 5, 5′ along the circumference of the transmitter wheel 1 can be provided. Also, a combination of a periodic and an aperiodic arrangement of the conductor bars 5, 5′ is possible. In this manner, the sensor/transmitter system can be adapted to the intended case of application such that an exact measurement of the rotational speed and/or rotational direction and/or other signal information is possible.

Also, the number of layers of conductor bars can be adapted as a function of the application. In the embodiment according to FIG. 5, the conductor bar groups 13, 14 are arranged in two layers above each other. The sensor element can however also be designed such that it is embodied with four layers, six layers, eight layers . . . . In this way, the magnitude of the signal level can be influenced also.

A further adjusting possibility resides in adapting the distance between the conductor bars 5, 5′ to the case of application. For example, it is possible that the distance between the conductor bars 5, 5′ corresponds to one fifth of the pole pitch τ. The distance between the conductor bars 5, 5′ is selected in any case such that a reliable charge separation is ensured.

FIG. 16 shows a sensor layout for a sensor element 2 that is comprised of six layers (layer 1 to layer 6). The sensor element has as a printed board a flexible film-type support 21 which, for example, has a rectangular contour and is comprised of polyimide, for example.

The support 21 is folded along the bending lines 22 which are extending transversely to its longitudinal direction such that the layers 1 to 6 are resting on each other (FIG. 17). The layers 1 to 6 have each the same width so that in the folded state they are congruently positioned on each other.

Each layer 1 to 6 is provided near the longitudinal rims of the support 21 with through openings 23. When the layers 1 to 6 are resting on each other, then these through openings 23 are also congruently positioned on each other. Through them, fastening means can be pushed in order to fixedly connect to each other the layers 1 to 6 resting on each other.

The support 21 is provided with four conducting wires 24 to 27 which are connected to the evaluation electronics 4. These conducting wires can be comprised of copper, silver, gold, platinum or nickel, for example. The conducting wires 24 and 25 are arranged approximately in a meander shape in such a way that the conductor bars 5 are formed which extend perpendicularly to the longitudinal direction of the support 21. In the embodiment, the conductor bars 5 have the same distance from each other. They are embodied such that they each have a distance from the neighboring longitudinal rims 28, 29 of the support 21. The conductor bars 5 form two sensors.

The conducting wires 24, 26 are respectively bent such that both ends are connected to the evaluation electronics 4.

The support 21 comprises in the illustrated embodiment the six layers (layers 1 to 6) which are connected to each by bending along the bending lines 22 so as to rest on each other. In this way, a very compact configuration of the sensor element is achieved.

The two sensors are located on both sides of the support 21. Behind the last layer of the sensors, a high permeable material is provided, preferably mu-metal. Mu-metal has a high permeability which causes the magnetic flux of low-frequency magnetic fields to concentrate in the material. In particular, by the use of this material a useful signal is reinforced by magnetic return generation but also by shielding against disturbing fields. In a motor vehicle, such disturbing fields can be produced by electric motors or starters, for example. As high permeable material, also ferritic films, thin transformer plate but also hard or soft magnetic materials are conceivable.

Depending on the case of application, arbitrary variants can be produced and manufactured in the end. Thus, multi-layer, such as three, four, five layer, layouts can be established and manufactured. For example, the number of layers depends on the rotational speed of the rotating machine part and/or on the distance between the transmitter wheel 1 and the sensor element 2 and/or on the pole pitch of the transmitter wheel 1. The lower the rotational speed of the rotating component, the smaller are also the voltages achievable by the conductor bars 5. Therefore, several layers are used in case of lower rotational speeds. Also, it is advantageous to employ a correspondingly larger number of layers for smaller pole pitch.

FIG. 17 shows a concrete example of the multi-layer sensor element 2 folded multiple times and connected to the evaluation electronics 4.

When the sensor element is used for rotational applications, it can be shaped in accordance with the diameter of the rotating component. In this context, the sensor element 2 can be designed such that it extends only about a portion of the circumference of the transmitter wheel 1, as illustrated in an exemplary fashion in FIGS. 1 and 2. For increasing the measuring precision, the sensor element 2 can also extend about an angle range of 360° (FIG. 3).

In order to achieve an absolute rotational position recognition by a magnetization of the transmitter wheel 1, additional information can be integrated into the magnetization pattern of the transmitter wheel 1. Such additional information is, for example, the frequency or the amplitude of the induced voltage U_{ind}. Also, by periodic/aperiodic repeating magnetization patterns, the absolute rotational position recognition can be achieved. This has been explained in an exemplary fashion with the aid of FIGS. 6 to 8.

By a suitable combination of uniform and/or non-uniform arrangement of the conductor bars 5, 5′ and a uniform and/or non-uniform magnetization of the encoder 1, a precise incremental rotational position (angle position) recognition can be realized.

FIG. 25 shows in an exemplary fashion the combination of a uniform magnetization and a non-uniform arrangement of the conductor bars 5, 5′. The poles 17 are identically embodied while the conductor bars 5, 5′ are arranged such that they have different distance from each other, viewed across the length of the encoder 1.

FIG. 26 shows an embodiment in which a uniform bar arrangement is combined with a non-uniform magnetization. The conductor bars 5, 5′ have across the length of the encoder the same distances from each other while the poles 17 of the encoder 1 are differently designed.

The simple configuration of the sensor element 2 provides the possibility of positioning in a simple manner several sensor elements 2 in relation to the transmission wheel 1. In this way, the signal tapping can be realized at one location. These multiple sensor elements 2 can be realized parallel with a multi-track transmitter wheel 1. However, it is also possible to configure a plurality of sensor elements 2 with phase displacement. In this case, a single track transmitter wheel 1 is sufficient as an encoder.

The multi-track configuration which is frequently realized in transmitter wheels can also be realized in a corresponding sensor arrangement. In an extreme case, a multi-dimensional bit space can be generated with a number x of sensor elements 2 and a number y of tracks on the transmitter wheel 1 as an encoder.

FIG. 18 shows in an exemplary fashion a sensor layout with three sensors A, A′, and B which each have the conducting bars 5. Within their group, they have the same length and the same distance relative to each other. The sensors A and A′ are displaced relative to each other by half the bar distance. The sensor B recognizes the reference mark. The conductor bars 5 are arranged on the support 21 of the sensor element 2. The ends of the conducting wires which form the conductor bars 5 are connected to the evaluation electronics 4 which is only schematically indicated in FIG. 18. The conductor bars 5 extend, as in the preceding embodiments, transversely to the rotational direction of the transmitter wheel 1 (FIG. 5). The conductor bars 5 are part of conducting wires whose ends are connected to the evaluation electronics 4.

The multi-layer configuration of the sensor element 2 leads to an increase of the signal level and thus to an improvement of the measuring precision. The multi-layer configuration of the sensor element 2, as described, can be achieved by folding the support 21. A multi-layer configuration can be achieved also by coiling the support 21, for example.

By folding the sensor element 2, multiple sensors in the form of the conductor bars 5, 5′ or conducting wires 24 to 27 can be arranged in multiple planes. The described employed material enables a higher temperature resistance and temperature stability of the sensor than the conventional sensors which have been used up to now, such as Hall or AMR sensors. In this way, the sensor element can be integrated into components which must be subjected to a vulcanization.

Due to the use of the high permeable materials, the total reluctance can be reduced so that the magnetic flux and the magnetic flux density in the magnetic circuit are increased.

Furthermore, shielding against outer foreign fields can be reliably done by use of the high permeable materials in or at the sensor element.

When a plurality of sensors in the form of conductor bars 5, 5′ are used, a rotational direction recognition is possible.

The sensor element 2 can cover across a defined region of the circumference of the transmitter wheel. In this way, summation and individual pitch errors can be effectively compensated. In the maximum case, the coverage can amount to up to 360° or even more. Moreover, there is the possibility of arranging the sensor elements 2 in a divided arrangement, or distributed arrangement in certain areas, about the circumference of the transmitter wheel 1.

Since the sensor element 2 covers a defined region of the circumference, the summation and individual division errors can be compensated. In the maximum case, this coverage can be up to 360°, as illustrated in FIG. 3. In FIG. 19, the signal course 30 for the sensor element 2 and the signal course 31 for the transmitter wheel 1 are illustrated. It is indicated in an exemplary fashion that the signal course 31 of the transmitter wheel 1 comprises an irregularity. The sensor element 2, on the other hand, shows a uniform course of the curve 30, in particular also in the region in which the curve 31 of the transmitter wheel 1 comprises an error. In this way, it is possible to compensate the error that is caused by the transmitter wheel 1 by means of the signals of the sensor element 2.

A reliable absolute rotational position recognition is possible by a corresponding magnetization of the transmitter wheel 1 (frequency/amplitude modulated).

The sensor element 2 can be produced in a simple way, based on printed board technology, for example, by 3D print, screen printing or other known methods.

The conductor bars 5, 5′ or the conducting wires 24 to 27 are advantageously comprised of copper, but can also be manufactured of other materials, for example, with corresponding, as needed, even better electrical properties.

The conductor bars 24 to 27 are simple metal wires and no semiconducting material anymore. This contributes to an inexpensive manufacture of the sensor elements.

The embodiments concern rotational applications. The sensor/transmitter system can, of course, be used also for applications in which linear movements are performed.

On the transmitter wheel 1, an arbitrary pole pattern can be applied that is positioned opposite a corresponding arrangement of the conductor bars 5, 5′ of the sensor element 2. In this way, the measuring precision, the absolute position recognition and the like are improved.

The sensor/transmitter system operates very energy-efficiently and can thus be designed with minimal expenditure to be self-sufficient with respect to energy. The voltage tapping is realized on one side at the respective conducting wire 24 to 27. This contributes to a simple configuration.

FIGS. 20 and 21 show the possibility of providing the sensor element with three sensors S1 to S3.

FIG. 21 shows the corresponding circuit diagram. The sensors S1 to S3 are, for example, electrically connected to each other by a delta connection. With such a connection of the sensors S1 to S3, the level of the sensor voltage can be increased. Other connections are also possible.

The three sensors S1 to S3 are each provided displaced by ⅔ of a pole pitch τ. In this way, the rotational angle of the shaft can be determined with high resolution.

The transmitter wheel 1 comprises the permanent magnets 17 with the illustrated pole pattern. The conductor bars 5 of the three sensors S1 to S3 are positioned perpendicularly to the movement direction of the transmitter wheel 1. The conductor bars 5 are connected with one end to the reference potential 15. The other ends are connected to each other by the delta connection.

Each sensor S1 to S3 has two conductor bars 5, respectively.

By a power supply unit 7 based on the sensor principle, the evaluation electronics 4 can be supplied with energy so that the entire sensor system can be self-sufficient with respect to energy. This is illustrated in an exemplary fashion in FIG. 22. The sensor element 2 is correlated with the transmitter wheel 1. The evaluation electronics 4 obtains from the transmitter sensor element system the supply voltage 8 and the sensor signals 3′.

FIG. 23 shows in an exemplary fashion a two-track transmitter wheel 1 in which the permanent magnets 17 are arranged in two tracks 32 and 33. The permanent magnets 17 can have different pole patterns in both tracks 32, 33, as can be seen in FIG. 23.

The two tracks 32, 33 each have correlated therewith a sensor 34, 35. The sensors 34, 35 can be embodied in accordance with the described embodiments. The simple configuration of the sensors, as explained with the aid of the various embodiments, enables a very simple positioning relative to the encoder 1 or its tracks 32, 33. The sensors 34, 35 can extend, as illustrated, only about a portion of the circumference of the encoder but also across 360°.

By a suitable sensor encoder arrangement, further information can be detected and utilized. Thus, for rotational applications, for example, shaft run-out can be determined in a simple and reliable way. FIG. 24 shows in a schematic illustration a corresponding embodiment. Illustrated is a high-pole permanent-excited transmitter wheel 1 that comprises the permanent magnets 17 about its circumference. The system comprises also two sensors 36, 37 that are displaced by 180 degrees relative to each other and comprise, for example, a flexible printed board as support 21. On both sides of the printed board 21, the sensor structure with the conductor bars 5 arranged in a meander shape are provided which are electrically conductingly connected in the described manner. So that the induced voltages of the conductor bars 5 summate on the sensor 36, 37 formed in a partial arc shape, the conductor bars 5 must have the same angle distance relative to each other as the poles at the circumference of the transmitter wheel 1.

As an example, with the inner layer of conductor bars 5 the rotational speed of the transmitter wheel 1 and with the conductor bars 5 of the outer layer of the sensor a shaft run-out of the transmitter wheel 1 are detected. The shaft run-out of the transmitter wheel 1 is indicated by the illustrated eccentricity 38 of the transmitter wheel 1. The degree of eccentricity 38 leads to the distance of the two sensors 36, 37 changing upon rotation of the transmitter wheel 1. This is illustrated in FIG. 24 in the right illustration by the dashed line 39. This different distance between the rotating transmitter wheel 1 and the sensor 36, 37 is detected by the conductor bars 5 on the outer layer of the sensors. In this way, an undesirable shaft run-out can be detected immediately so that early on counter measures can be taken.

The described embodiments can be installed directly in the respective application. Due to the integration of the sensor element 2 in the application, the tolerance chain can be kept small so that the measuring precision is increased. No additional measures for centering, positioning, and assembly of a sensor/transmitter system are required which significantly reduces the manufacturing costs.

In comparison to known complex Hall sensor systems, the described sensor/transmitter system can be produced inexpensively.

The sensor or sensors including further electrical/electronic components, in particular capacitors, can be produced by printed board printing technology on flexible printed boards in a simple and inexpensive manner. As a result of the constructively simple configuration and embodiment of the sensor element 2, a high robustness as well as a very long service life result.

The sensor can also be directly applied in the application or on corresponding components, for example, by printing.

The described sensor/transmitter system can be used for rotational (axial, radial) as well as for linear applications.

What is claimed is:

1.-17. (canceled)

18. A sensor unit for a sensor/transmitter system for detecting at least rotational and linear movements of a component comprising magnetic poles, the sensor unit comprising:
a sensor formed by an electrically conducting conductor bar positioned transversely to a movement direction of a magnetic field of the component, wherein the conductor bar is part of a conducting wire arranged in a meander shape, wherein in the conductor bar, by a relative movement between the magnetic field of the component and the conductor bar, a voltage is produced; and
an evaluation electronics configured to evaluate the voltage produced in the conductor bar and supplied to the evaluation electronics.

19. The sensor unit according to claim 18, wherein the voltage is produced by a charge separation in the conductor bar.

20. The sensor unit according to claim 18, further comprising a support wherein the conductor bar is arranged on the support.

21. The sensor unit according to claim 18, wherein the support has a first side and a second side facing away from the first side, wherein a plurality of said conductor bar are provided, wherein the plurality of said conductor bar includes a first conductor arranged on the first side and includes a second conductor bar arranged on the second side.

22. The sensor unit according to claim 21, wherein the first conductor bar and the second conductor bar are electrically conductingly connected to each other.

23. The sensor unit according to claim 21, further comprising a high permeable layer positioned behind the first and second conductor bars.

24. The sensor unit according to claim 21, wherein the first conductor bar on the first side is configured to detect a movement of the component and the second conductor bar on the second side is configured to detect one or more of a movement imprecision of the component, a shape deviation of the component, and a position deviation of the component.

25. The sensor unit according to claim 20, wherein the support comprises at least one bending line for folding the support.

26. The sensor unit according to claim 20, wherein the support is connected to the evaluation electronics.

27. A sensor/transmitter system for detecting at least rotational and linear movements, the sensor/transmitter system comprising:
a component comprising magnetic poles; and
a sensor unit correlated with the magnetic poles, wherein the sensor unit comprises:
a sensor formed by an electrically conducting conductor bar positioned transversely to a movement direction of a magnetic field of the component, wherein the conductor bar is part of a conducting wire arranged in a meander shape, wherein in the conductor bar, by a relative movement between the magnetic field of the component and the conductor bar, a voltage is produced; and
an evaluation electronics configured to evaluated the voltage produced in the conductor bar and supplied to the evaluation electronics.

28. The sensor/transmitter system according to claim 27, wherein the component is an encoder.

29. The sensor/transmitter system according to claim 28, wherein the magnetic poles are permanent magnets or solenoids arranged on the encoder.

30. The sensor/transmitter system according to claim 28, wherein the encoder is magnetized for forming the magnetic poles.

31. The sensor/transmitter system according to claim 27, wherein the sensor unit comprises a plurality of said conductor bar arranged to match a pole pitch of an arrangement of the magnetic poles.

32. The sensor/transmitter system according to claim 27, wherein the sensor unit comprises at least two of said conductor bar, wherein the sensor unit extends across 360°, and wherein the magnetic poles of the component provide a magnetization pattern with a uniform pole pitch.

33. The sensor/transmitter system according to claim 32, wherein the magnetization pattern comprises at least one reference mark.

34. The sensor/transmitter system according to claim 27, wherein the sensor unit comprises at least two of said conductor bar, wherein the sensor unit extends across 360°, and wherein the magnetic poles of the component provide a magnetization pattern with a non-uniform pole pitch.

35. The sensor/transmitter system according to claim 27, wherein the sensor unit comprises a support and wherein a plurality of said conductor bar are arranged on the support, wherein the plurality of said conductor bar are configured to provide different signal evaluations.

36. The sensor/transmitter system according to claim 27, wherein at least two of said sensor unit are arranged along the component.

37. The sensor/transmitter system according to claim 27, wherein the component is magnetized such that an amplitude modulation and/or frequency modulation is possible.

38. The sensor/transmitter system according to claim 27, wherein the component is absolute-coded according to the vernier principle.

39. The sensor/transmitter system according to claim 27, wherein, for influencing a signal level, the magnetic poles of the component are positioned differently in a targeted manner in an axial direction (y direction) of the component.
